(19) United States
(12) Patent Application Publication
(10) Pub. No.: US 2018/0056357 A1
(43) Pub. Date: Mar. 1, 2018

(54) PRODUCTION SYSTEM WITH A MANIPULATION DEVICE

(71) Applicant: TRUMPF Maschinen Austria GmbH & Co. KG., Pasching (AT)

(72) Inventors: Rudolf KUBINGER, Kallham (AT); Johann MAYRHOFER, Nussbach (AT)

(73) Assignee: TRUMPF Maschinen Austria GmbH & Co. KG., Pasching (AT)

(21) Appl. No.: 15/535,816

(22) PCT Filed: Dec. 11, 2015
(86) PCT No.: PCT/AT2015/050315

§ 371 Date: Nov. 13, 2017

(30) Foreign Application Priority Data
Dec. 15, 2014 (AT) A 50903/2014

(51) Int. Cl. B21D 5/02; B21D 43/00; B21D 5/00; B21D 43/10; B25J 15/02

(52) U.S. Cl. CPC B21D 5/0281; B21D 43/003; B25J 15/0273; B21D 5/002; B21D 43/105; B21D 5/0254

(57) ABSTRACT

The invention relates to a production system (1) comprising a bending tool (11), a tool store (12), a bending machine (4) and a manipulation device (13) which performs a travelling movement from a tool store position located in the region of the tool store (12) to a machine operating position located in the region of the bending machine (4). A first coupling element (18) is arranged on the manipulation device (13) and a second coupling element (19) is arranged on the bending machine (4). In the machine operating position, the two coupling elements (18, 19) are coupled together, through which the manipulation device (13) is fixed in position relative to the bending machine (4) and thus a reference position is set.

The invention relates to a production system, in particular for the free-form bending of tools made of sheet metal or plates as described in the preamble of claim 1.

In the prior art thus far, the travelling motion of the manipulation device relative to the bending machine has been executed on rails or other physically rigid guiding mechanisms. This allowed the manipulation device to be positioned quite precisely relative to the bending machine. The manipulation device was fixed in position on at least one of the rails. The disadvantages in this are the rigid execution of the transport paths and the limited free working area on the front or operating side of the bending machine typically caused by the rails.

The purpose of the present invention is to create a production system, in particular for the free-form bending of tools made of sheet metal or plates, in which a manipulation device that can travel relative to a bending machine is in a machine operating position located in the region of the bending machine in a fixed position relative to the bending machine. In addition, an obstacle-free working area is to be created for the operator at least in the region of a front side or operating side of the bending machine. Furthermore, flexible options to arrange the transport paths are to be rendered possible.

This purpose of the invention is achieved in that at least one first coupling element is arranged or constructed on the at least one manipulation device and at least one second coupling element is arranged or constructed on the at least one bending machine, and that in the machine operating position the at least one manipulation device couples the at least one first coupling element of the manipulation device to at least one of the second coupling elements of the bending machine and therefore the at least one manipulation device is fixed in position relative to the at least one bending machine and thus a reference position is set.

The advantages achieved by the characterising features of claim 1 are that this allows a contactless or rail-less travelling movement of the manipulation device between the individual components of the production system and that the manipulation device still has a stationary, fixed position on the bending machine, in particular its machine frame, when in the machine operating position. Since the coupling elements can engage with each other, they can be used to set the corresponding reference position, e.g. by mechanical means. After the engaged coupling elements are decoupled, the corresponding travelling paths along the stipulated or predefined transport paths can be executed independently by the manipulation device as needed.

It is further advantageous if multiple second coupling elements are arranged next to each other on the bending machine. This allows multiple reference positions to be clearly set, preferably next to each other, on the bending machine. In addition, in this way multiple manipulation devices can be placed simultaneously next to each other in a corresponding machine operating position on one of the bending machines.

Another embodiment is characterised by the second coupling element placed on the bending machine being formed by at least one coupling rail. The design of the second coupling element as a coupling rail allows numerous reference positions to be defined or set next to each other on larger or longer bending machines.

Another possible embodiment has the characterising features that the at least first and the at least second coupling element form a mechanically constructed coupling device when in the coupled position. This makes it possible to achieve a reference position that can be created with high precision in the coupled position of the coupling elements.

Another design provides that the at least one bending tool held on the tool sockets defines a work plane oriented in the vertical direction and extending in the longitudinal direction of the tool sockets and the multiple second coupling elements arranged next to each other or the at least one coupling rail is or are arranged at an equal distance in the vertical direction relative to the work plane. This way multiple reference positions next to each other and exactly aligned with each other can always be set on the bending machine relative to the work plane.

Another embodiment is characterised by the at least one manipulation device being arranged in the region of a front side of the at least one bending machine when in a machine operating position. This makes it possible not only to switch the bending tool on the tool sockets, but also to execute simple bending procedures via the manipulation device together with the bending machine automatically and without the assistance of a machine operator.

Another preferred embodiment is characterised by the at least one manipulation device being connected to an energy supply line arranged on the at least one bending machine when in a machine operating position. This makes it possible to supply the manipulation device with energy, e.g. electrical energy, in the coupled position. It is possible, for example, to charge an energy store, such as a battery, for the travel drive or to operate the gripping arm of the manipulation device.

It is also advantageous if, when in the machine operating position, the at least one manipulation device is connected to a data link to a machine control and/or a production planning system arranged on the at least one bending machine. This way, when in a position docked to the bending machine, a data or program transfer can take place from the bending machine or its machine control or a production planning system to the manipulation device, in particular to its computer and/or storage device. This makes it possible to transmit information for the actions to be performed by the manipulation device to it and to store this information there.

Another embodiment is characterised by the at least one manipulation device comprising a computing unit and/or a storage unit. This makes it possible to be able to store program steps to be performed directly on the manipulation device and to have the manipulation device then perform them automatically.

Another possible embodiment has the characterising features that the at least one manipulation device comprises a gripping arm with at least one gripping organ, which at least one gripping organ can be connected to the at least one bending tool, in particular its bending punch or bending die. This way the bending tool to be manipulated can be taken out of the at least one tool store, then moved to the bending machine, and a tool switch can be performed on the bending machine in one of the machine operating positions.

Another design provides that the gripping arm with its at least one gripping organ can be brought into a position clamping the sheet metal or plate. This serves, among other things, to make it possible to insert the sheet metal or plate into the bending tool for the bending process and remove it from the bending tool after the bending process. In addition, however, the sheet metal or plate can be removed from the raw material store and potentially stored temporarily on the manipulation device. A handling process can also take place in the course of the bending process, assisted by the manipulation device or even performed by it.

Another embodiment is characterised by the at least one manipulation device having a temporary store arranged or constructed on it for the at least one bending tool. Providing at least one temporary store creates the option of the manipulation device picking up the required bending tool or bending tools out of a tool store and temporarily storing it or them on the manipulation device for transport to the bending machine. In addition, return transport of no longer needed bending tools from the bending machine to the tool store is also possible.

Another preferred embodiment is characterised by the at least one manipulation device having at least one first storage surface arranged or constructed on it for the work piece(s) to be manufactured out of the sheet metal or plate. This way transport of sheet metal or plates to be shaped or bent can also be executed directly by the manipulation device without the assistance of an operator.

It is further advantageous if at least one second storage surface is arranged or constructed on the at least one manipulation device for the manufactured work piece(s). This makes possible the automatic execution of simple bending processes directly by the manipulation device. For example, the manipulation device can remove the sheet metal or plate to be bent from a first storage area using its gripping arm and the attached gripping organ and move it to the working area of the bending machine. During execution of the bending process, the manipulation device can perform a clamping hold on the sheet metal or plate. When the bending process is completed, the manipulation device can deposit the completed work piece on the provided second storage surface. Independent transport away to the work piece store can then follow.

Another embodiment is characterised by the at least one manipulation device being equipped with at least one optical capture device. Providing at least one optical capture device makes it possible to, for example, detect the position of the sheets to be bent or processed. Finished work pieces can also be detected in this way. However, it would further be possible to detect the bending tool or its bending tool components in this way.

Another possible embodiment has the characterising feature that the at least one tool store is distanced and spatially separated from the at least one bending machine. This way additional attachments for tool storage can be omitted in the region of the bending machine. In addition, however, a central store for multiple bending machines can be created in order to supply a larger number of bending machines in a production system from a common tool store with the bending tools needed for each particular bending process.

Another design provides that the production system comprises at least one raw material store for the sheet metal or plates to be bent, which raw material store is preferably distanced and spatially separated from the at least one bending machine. This can save space in the region of the bending machine because the manipulation device can facilitate transport there and away.

Another embodiment is characterised by the production system comprising at least one work piece store for the work pieces manufactured from the sheet metal or plates, preferably distanced and spatially separated from the at least one bending machine. Providing at least one work piece store can create adequate free space around the bending machines, allowing a higher machine density to be reached.

Another preferred embodiment is characterised by the existence of a contactless guide for the travelling movement of the at least one manipulation device between the at least one tool store and the at least one bending machine or between the raw material store and/or the work piece store and the at least one bending machine of the at least one manipulation device along the transport paths. Providing the contactless guide for the manipulation device in the region of the production system between the individual facility components can create individual definition or arrangement of the transport paths. In addition, however, rigid rail systems that disrupt the operating personnel, in particular their working area on the bending machine, can be omitted. It is also easier to accommodate changing transport paths, since these can be changed or reconfigured quickly and easily depending on the choice of contactless guide.

Finally, it is advantageous if the contactless guide is chosen from the group of induction strips, magnetic strips, longitudinal stripes or inked ribbons and optical detection thereof, GPS navigation, D-GPS navigation, laser navigation, data matrix code. This creates an option for the user to choose a contactless guide and its means of guiding easily and therefore to choose and apply them as needed.

To facilitate better understanding of the invention, it will be explained in detail using the figures below.

Extremely simplified, schematic depictions show the following:

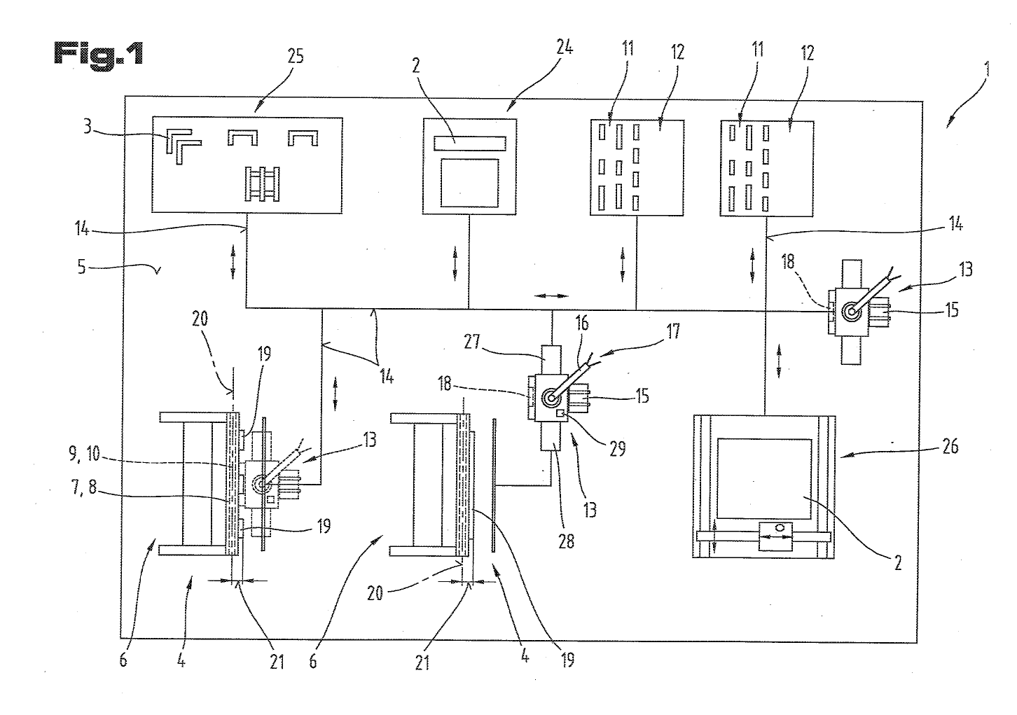

FIG. 1 A potential design of a production system in a top view;

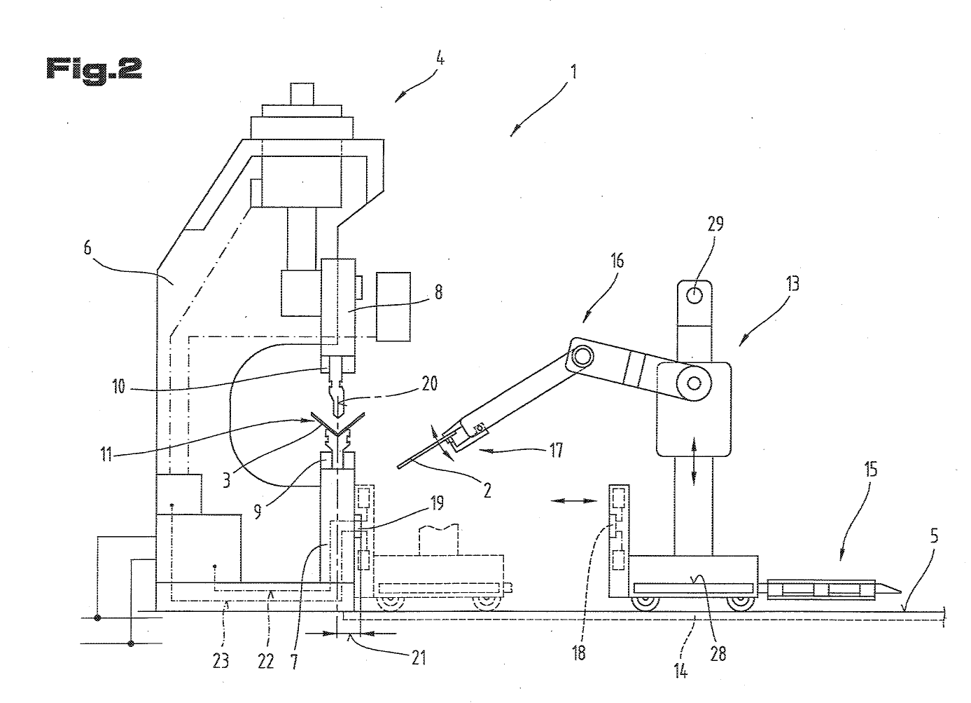

FIG. 2 The bending machine with a manipulation device located in the region of its front side, before the docking procedure of the coupling elements, in side view.

In introduction, let it be noted that in the variously described embodiments, identical parts are provided with identical reference signs or identical part names, and that the disclosures contained in the description as a whole can be carried over analogously to identical parts with identical reference signs or identical part names. Likewise, positional information selected in the description, e.g. above, below, on the side, etc. refer to the directly described and depicted figure and if the position is changed, this positional information carries over analogously to the new position. The term “in particular” is used below to refer to a potentially more specialist design or more detailed specification of an object or process step, which need not necessarily constitute a mandatory, preferred embodiment.

FIGS. 1 and 2 show a very simplified schematic depiction of a production system 1 for work pieces 3 to be manufactured from sheet metal 2 or plates. The sheet metal 2 or plates are processed in a bending process, in particular in what is known as free-form bending. A stylised portrayal of the outline or top view was chosen for the depiction in FIG. 1.

The production system 1 can comprise multiple components, of which several will be described and characterised in greater detail below. It is basically possible for individual system components to be combined with each other as desired and arranged spatially in relation to each other as desired.

Thus the production system 1 can comprise at least one, but also multiple bending machines 4, which are e.g. set up or arranged in a production hall or another building on a hall floor 5. The hall floor 5 is usually a support surface arranged as a plane or preferably as a level surface. Depending on load or dead weight, it can also be possible for parts or machines with a high mass to be supported on a foundation provided separately for them. The bending machine 4 can, for example, be a bending press, in particular an edging press. The bending machine 4 comprises at least one machine frame 6 with usually one fixed lower press beam 7 and one upper press beam 8 that can be adjusted relatively in the vertical direction, as is generally known. Also shown in simplified form here is that tool sockets 9, 10 are arranged or constructed on each of the press beams 7, 8. The tool sockets 9, 10 are indicated by dotted lines.

To execute the bending process, the production system 1 further comprises at least one bending tool 11, which is in the known manner formed of at least one bending punch and at least one complementary bending die. Since this is also sufficiently known, the detailed design of the bending tool 11 will not be discussed further here.

The production system 1 further comprises at least one tool store 12 for the bending tool(s) 11. The tool store(s) 12 serve(s) to stock the bending tools 11 needed for the relevant bending and reshaping processes and to hold them available for pick-up as needed. Usually multiple, preferably different bending tools 11 and/or their bending tool components are stored here.

The previously described tool sockets 9, 10 on the press beams 7, 8 act to hold the at least one bending tool 11.

In this example embodiment, the production system 1 further comprises at least one manipulation device 13. In the example embodiment shown here, the manipulation device 13 is designed to be freely self-driving and therefore executes the travelling movements, e.g. between the at least one bending machine 4 and the at least one tool store 12 or other stations or stores described below. A possible transport path 14 or multiple thereof are shown in simplified form with dashes between the individual components of the production system 1 and can, depending on design, be arranged or constructed e.g. running directly on the hall floor 5. The transport path 14 can also be called a transport route or travel path.

If, for example, a bending tool 11 or a tool set is to be moved or transported from one of the tool stores 12 to one of the bending machines 4, the manipulation device 13 travels along the predefined transport path 14 using a contactless guide along the predefined transport path 14.

The hall floor 5 is preferably constructed to be completely level to allow unhindered rail-less travelling movement of the at least one manipulation device 13 at least in the region of the transport path(s) 14. The drive of the manipulation device 13 can, for example, consist of at least one drive wheel and a connected drive unit. Drive rolls, drive drums, or similar drive organs such as drive chains and the like can also be used in place of drive wheels.

If the manipulation device 13 is in the vicinity of one of the tool stores 12 in order to remove and/or return bending tools, this position of the manipulation device 13 can be termed the tool store position. In this tool store position, it is possible not only to effect or execute the receipt of at least one bending tool 11 and/or tool set from the tool store 12 to the manipulation device 13 but also the return or placement into storage of the bending tool 11 from the manipulation device 13 into the tool store 12. In order to accept the bending tool 11, the at least one manipulation device 13 can have a temporary store 15 arranged or constructed on it for the at least one bending tool 11.

In order to perform these manipulation movements of the bending tool 11, the at least one manipulation device 13 can comprise a gripping arm 16 with at least one, preferably tong-shaped gripping organ 17. This makes it possible for the manipulation device 13 to use the gripping organ 17 and appropriate control and regulation commands to be able to pick up, hold, manipulate, and set down the at least one bending tool 11, in particular its bending punch or bending die. To control and/or regulate these manipulation processes, the at least one manipulation device 13 can also comprise a computing unit and/or a storage unit.

If the bending tool(s) are picked up by the manipulation device 13, the manipulation device 13 executes the travelling movement from the tool store position in the region of the tool store 12 along the transport path 14 to a machine operating position in the region of the bending machine 4. This way the bending tool 11 can be moved starting from the tool store 12 to the bending machine 4, in particular to its tool sockets 9, 10.

As already described briefly above, the travelling movement of the at least one manipulation device 13 between the at least one tool store 12 and the at least one bending machine 4 proceeds along the transport path(s) by means of a contactless guide. Thus, for example, the contactless guide can be chosen from the group of induction strips, magnetic strips, longitudinal stripes or inked ribbons and optical detection thereof, GPS navigation, D-GPS navigation (Differential Global Positioning System), laser navigation, data matrix code. The differently designed strips can be attached, in particular stuck on to the hall floor 5 as needed. Since these usually have a rather small thickness or strength, they do not disrupt the travelling motion of the manipulation device 13 or the operating personnel. It would also be possible to design the contactless guide or direction elements to sit deeper in the hall floor 5, allowing better protection of them against destruction or the like.

This way the construction of separate, physically higher guide rails or other mechanical guide devices that project past the level of the hall floor 5 can be omitted in the region of the hall floor 5. Thus a nearly or completely level hall floor or a level support surface without disrupting or projecting parts can be created for contactless guiding of the manipulation device 13.

If the at least one manipulation device 13 has reached the at least one machine operating position located in the region of the bending machine 4 along the transport path 14, the manipulation device 13 must be kept in fixed position in a corresponding reference position relative to the bending machine 4. To achieve this, the at least one manipulation device 13 has at least one first coupling element 18 arranged or constructed on it. At least one second coupling element 19 is furthermore arranged or constructed on the at least one bending machine 4. It is shown on the bending machine 4 represented in the left lower region of the production system 1 that multiple second coupling elements 19 can be arranged next to each other on the bending machine 4. Depending on the longitudinal extension of the bending machine 4 in the longitudinal direction of the tool socket 9, 10, it is, for example, possible for only one second coupling element 19 to be enough.

The simplified depiction of the bending machine 4 shown in the lower middle shows that the second coupling element 19 provided on the bending machine 4 can, for example, be formed by at least one coupling rail. The coupling rail is preferably designed to be continuous and therefore allows numerous machine operating positions arranged next to each other viewed in the direction of their longitudinal extension for the at least one manipulation device 13. To allow fixed positioning and the associated setting of the reference position of the manipulation device 13 relative to the bending machine 4, the at least one first coupling element 18 of the manipulation device 13 is coupled to at least one of the second coupling elements 19 of the bending machine 4.

The at least one first coupling element 18 and the at least second coupling element 19 form a preferred mechanical design for a coupling device when in their coupled position. The design of the coupling device realises a precisely pre-positioned, fixed positioning of the manipulation device 13 in its machine operating position. The co-ordinated coupling elements 18, 19 can be designed in quite different ways whereby fixed positioning and the associated setting of the reference position of the manipulation device 13 relative to the bending machine 4 are achieved. The coupling elements 18, 19 can be constructed on a mechanical basis, but also based on an electro-mechanical or magnetic effect.

It is further shown on the bending machine 4 on the lower left that the at least one bending tool 11 held in the tool sockets 9, 10 defines a work plane 20 oriented in the vertical direction and extending in the longitudinal direction of the tool sockets 9, 10. This way the coupling surfaces of the second coupling elements 19 that are facing the first coupling elements 18 or the at least one coupling rail can be arranged or constructed at an equal distance 21 in the perpendicular direction relative to the work plane 20.

To facilitate the accessibility of the manipulation device 13, in particular of its gripping arm 16 to the tool sockets 9, 10, the at least one manipulation device 13 is arranged in one of the machine operating positions in the region of a front side of the at least one bending machine 4. The front side of the bending machine 4 is the side that is also provided for the machine operator for his or her work activities. To allow the travelling movement of the manipulation device 13 to reach different machine operating positions on the bending machine 4, the transport path 14 can also be defined or arranged as extending in the parallel direction relative to the work plane 20. Since the at least second coupling element 19 is also arranged in the region of the front side of the bending machine 4, the manipulation device 13 can not only perform a switch or exchange of bending tools 11 at the tool sockets 9, 10, but also automatically and independently execute potential simple bending processes in co-ordination with the bending machine 4.

FIG. 2 shows the manipulation device 13 in the region of the front side or operating side of the bending machine 4 before docking or coupling to the bending machine 4. The coupled position is only indicated by dashed lines, with only a part of the manipulation device 13 being depicted. To perform set-up or retooling processes and potentially machine-assisted bending work, the manipulation device 13 is moved and/or driven into the machine operating position and coupled. The fixed, contactless guide elements arranged on the hall floor 5 in order to form or define the transport path 14 are indicated by dashed lines recessed in the hall floor 5.

The at least one manipulation device 13 can be connected to an energy supply line 22 arranged on the at least one bending machine 4 when in a machine operating and docked position. Furthermore and independently of this, it would also be possible for, when in the machine operating position, the at least one manipulation device 13 to be connected to a data link 23 to a machine control and/or a production planning system not portrayed in more detail arranged on the at least one bending machine 4.

Also shown in simplified form—see FIG. 1—is that the production system 1 can also comprise at least one raw material store 24 for the sheet metal 2 or plates to be bent. The raw material store 24 is preferably arranged distanced and spatially separated from the at least one bending machine 4 in the region of the production hall or another building. It is also possible for the production system 1 to comprise at least one work piece store 25 for the work pieces 3 manufactured from the sheet metal 2 or plates after their processing by the bending machine 4. This work piece store 25 can also preferably be distanced and spatially separated from the at least one bending machine 4.

It would additionally also be possible for the production system 1 to also comprise a finishing device 26, for example for cutting the sheet metal 2 or plates to form the work pieces 3. All the previously described components of production system 1, namely the at least one bending machine 4, the at least one tool store 12, the at least one raw material store 24, the at least one work piece store 25, and the at least one finishing device 26 can be linked among or to each other by the previously described and potentially differently designed transport paths 14 to facilitate contactless guiding along these. This way the travelling movement of the at least one manipulation device 13 can also proceed between the at least one bending machine 4 and the raw material store 24 and/or the raw material store 24 and/or the work piece store 25 along the predefined transport paths 14.

To also allow transport of the sheet metal 2 or plates intended for the manufacture or production of the work pieces 3, at least one first storage surface 27 can be arranged or constructed on the at least one manipulation device 13. Not only bearing-based storage but also hanging storage is conceivable. Independently of this or in addition to it, it would also be possible for at least one second storage surface 28 to be arranged or constructed on the at least one manipulation device 13 for the completed work pieces 3. Storage surface here means a placement and/or transport space dependent on the spatial organisation and size/dimensions of the sheet metal 2 and/or the work pieces 3. The first storage surface 27 and/or the second storage surface 28 can, for example, by formed by fixed storage spaces arranged on the manipulation device 13. However, it would also be possible to provide at least one corresponding socket, e.g. for pallets, boxes or the like, on the manipulation device 13 in the form of fork teeth as used in forklifts. This way the first storage surface 27 and/or the second storage surface 28 and/or the temporary store 15 can only be formed by appropriate fork teeth which are known to be able to handle and transport e.g. pallets or other carrying devices. However, it would still further be possible to only provide or arrange a single storage or placement space on the manipulation device 13 for the sheet metal 2, the work pieces 3 produced from it, and the bending tools 11.

For handling the sheet metal 2 or plates and/or the work pieces 3 produced from them, the gripping arm 16 with its at least one gripping organ 17 can be brought into a position clamping the sheet metal 2 or the work piece 3.

As can further be seen from the depiction in FIG. 1, not only the raw material store 24 and/or the work piece store 25 can be arranged to be distanced and spatially separated from the bending machine 4, but also the tool store 12 and/or the finishing device 26.

However, it would still further be possible for the at least one manipulation device 13 to be equipped with at least one capture device 29, in particular an optical capture device. This would make it possible to detect the position of the sheet metal 2 to be picked up and/or transported, the work pieces 3 manufactured from it, and/or the bending tool 11.

In addition to but independently of this, it would also be possible to arrange or provide a cleaning device or cleaning system on the manipulation device 13. The cleaning system can be used to perform regular cleaning processes on the individual tool components of the bending tool 11 and/or the tool socket 9, 10.

By designing the manipulation device 13 as a self-driving component of the production system 1, it could also be equipped with a safety system. This may be, for example, a laser scanner with which different safety zones can be set or defined around the manipulation device 13. An outer safety zone could act to e.g. reduce the driving speed of the manipulation device 13 to e.g. avoid a collision. If, on the other hand, a foreign body enters into the inner safety zone or a smaller region, the travelling movement of the manipulation device 13 can be stopped. It would, however, additionally be possible to emit a signal tone.

This also creates the option of easy retrofitting of existing bending systems/production systems 1 by defining or providing the transport paths 14 and attaching the coupling elements 18, 19.

In addition, however, retooling processes and even simple bending processes can automatically be performed by the manipulation device 13 outside production times. This way a machine operator can find a bending machine 4 already equipped with the bending tool 11 for the bending processes on beginning his or her work. Valuable working time can be saved and the other equipping processes to be performed can be executed by the manipulation device 13 without assistance after corresponding data transmission.

The example embodiments show possible variations of the production system 1; let it be noted at this juncture that the invention is not limited to the specially portrayed variations of embodiments themselves, but that diverse combinations of the individual variations of embodiments are possible and that this possibility of variation falls within the competence of a person active in this technical field based on the teaching regarding technical action provided by this invention.

Furthermore, individual characteristics or combinations of characteristics from the depicted and described various example embodiments can constitute independent inventive or invented solutions.

The aim underlying the independent invented solutions can be taken from the description.

Above all, the individual embodiments shown in FIG. 1, 2 can form the subject of independent invented solutions. The relevant aims according to the invention and solutions can be found in the detailed descriptions of these figures.

As a matter of form, let it be noted that, to facilitate a better understanding of the design of the production system 1, it and its parts and components have in places been portrayed not to scale and/or enlarged and/or scaled-down.

### LIST OF REFERENCE SIGNS

1 Production system
2 Sheet metal
3 Work piece
4 Bending machine
5 Hall floor
6 Machine frame
7 Press beam
8 Press beam
9 Tool socket
10 Tool socket
11 Bending tool
12 Tool store
13 Manipulation device
14 Transport path
15 Temporary store
16 Gripping arm
17 Gripping organ
18 First coupling element
19 Second coupling element
20 Work place
21 Distance
22 Energy supply line
23 Data link
24 Raw material store
25 Work piece store
26 Finishing device
27 First storage surface
28 Second storage surface
29 Capture device

1: Production system (1), in particular for the free-form bending of work pieces (3) to be manufactured out of sheet metal (2) or plates, comprising at least one bending tool (11), which at least one bending tool (11) comprises at least one bending punch and at least one bending die; at least one tool store (12) for multiple bending tools (11); at least one bending machine (4), in particular a bending press with a machine frame (6) and press beams (7, 8) and tool sockets (9, 10) arranged or constructed on the press beams (7, 8) for the at least one bending tool (11); at least one manipulation device (13) by which the at least one bending tool (11) is moved by a travelling movement executed by the manipulation device (13) from a tool store position located in the region of the tool store (12) along a transport path (14) to at least one machine operating position located in the region of the bending machine (4) between the tool store (12) and the bending machine (4), in particular its tool sockets (9, 10); wherein the at least one manipulation device (13) has arranged or constructed on it at least one first coupling element (18) and the at least one bending machine (4) has arranged or constructed on it at least one second coupling element (19), and wherein the at least one manipulation device (13), when in one of the machine operating positions, has coupled the at least one first coupling element (18) of the manipulation device (13) to at least one of the second coupling elements (18) of the bending machine (4) and in this way the at least one manipulation device (13) is fixed in position relative to the at least one bending machine (4) and thus a reference position is set.

2: Production system (1) as in claim 1, wherein the bending machine (4) has multiple second coupling elements (19) arranged next to each other.

3: Production system (1) as in claim 1, wherein the second coupling element (19) placed on the bending machine (4) is formed by at least one coupling rail.

4: Production system (1) as in claim 1, wherein the at least first coupling element (18) and the at least second coupling element (19) form a mechanically constructed coupling device when in the coupled position.

5: Production system (1) as in claim 1, wherein the at least one bending tool (11) held on the tool sockets (9, 10) defines a work plane (20) oriented in the vertical direction and extending in the longitudinal direction of the tool sockets (9, 10) and the multiple second coupling elements (19) arranged next to each other or the at least one coupling rail is arranged at an equal distance (21) in the vertical direction relative to the work plane (20).

6: Production system (1) as in claim 1, wherein the at least one manipulation device (13) is arranged in the region of a front side of the at least one bending machine (4) when in a machine operating position.

7: Production system (1) as in claim 1, wherein the at least one manipulation device (13) is connected to an energy supply line (22) arranged on the at least one bending machine (4) when in a machine operating position.

8: Production system (1) as in claim 1, wherein the at least one manipulation device (13) is connected to a data link (23) to a machine control and/or a production planning system arranged on the at least one bending machine (4) when in a machine operating position.

9: Production system (1) as in claim 1, wherein the at least one manipulation device (13) comprises a computing unit and/or a storage unit.

10: Production system (1) as in claim 1, wherein the at least one manipulation device (13) comprises a gripping arm (16) with at least one gripping organ (17), which at least one gripping organ (17) can be connected to the at least one bending tool (11), in particular its bending punch or bending die.

11: Production system (1) as in claim 10, wherein the gripping arm (16) with its at least one gripping organ (17) is able to be brought into a position clamping the sheet metal (2) or plate.

12: Production system (1) as in claim 1, wherein the at least one manipulation device (13) has a temporary store (15) arranged or constructed on it for the at least one bending tool (11).

13: Production system (1) as in claim 1, wherein the at least one manipulation device (13) has at least one first storage surface (27) arranged or constructed on it for the sheet metal (2) or plates.

14: Production system (1) as in claim 1, wherein the at least one manipulation device (13) has at least one second storage surface (28) arranged or constructed on it for the completed work pieces (3).

15: Production system (1) as in claim 1, wherein the at least one manipulation device (13) is equipped with at least one optical capture device (29).

16: Production system (1) as in claim 1, wherein the at least one tool store (12) is distanced and spatially separated from the at least one bending machine (4).

17: Production system (1) as in claim 1, comprising at least one raw material store (24) for the sheet metal (2) or plates to be bent, which raw material store (24) is preferably distanced and spatially separated from the at least one bending machine (4).

18: Production system (1) as in claim 1, comprising at least one work piece store (25) for work pieces (3) produced from the sheet metal (2) or plates, which work piece store (25) is preferably distanced and spatially separated from the at least one bending machine (4).

19: Production system (1) as in claim 1, comprising the existence of a contactless guide for the travelling movement of the at least one manipulation device (13) between the at least one tool store (12) and the at least one bending machine (4) or between the raw material store (24) and/or the work piece store (25) and the at least one bending machine (4) of the at least one manipulation device (13) along the transport paths (14).

20: Production system (1) as in claim 19, wherein the contactless guide is chosen from the group of induction strips, magnetic strips, longitudinal stripes or inked ribbons and optical detection thereof, GPS navigation, D-GPS navigation, laser navigation, data matrix code.
